(19) United States
(12) Patent Application Publication
(10) Pub. No.: US 2011/0010249 A1
(43) Pub. Date: Jan. 13, 2011

(54) METHODS AND APPARATUSES FOR PROVIDING A SLEEP SYSTEM HAVING CUSTOMIZED ZONED SUPPORT AND ZONED COMFORT

(76) Inventors: Robert D. Oexman, Carthage, MO (US); David B. Scott, Carthage, MO (US)

Correspondence Address: SUGHRUE MION, PLLC, 2100 PENNSYLVANIA AVENUE, N.W., SUITE 800, WASHINGTON, DC, 20037, US

(21) Appl. No.: 12/933,604

(22) PCT Filed: Mar. 20, 2009
(86) PCT No.: PCT/US09/37754

§ 371 Date: Sep. 20, 2010

(30) Foreign Application Priority Data
Mar. 21, 2008 (US) 61/038644

(51) Int. Cl. A47C 23/04; A47C 27/00; G06Q 30/00

(52) U.S. Cl. 705/14.66; 5/727; 5/716; 5/720; 5/706

(57) ABSTRACT

A sleep support member and a method for recommending a sleep support member to a person. The sleep support member includes: a support layer including a plurality of support zones; and a comfort layer including a plurality of comfort zones, wherein the comfort layer is disposed above the support layer. Each of the support zones is configured to provide customized support characteristics to a corresponding region of a person's body and each of the comfort zones is configured to provide customized comfort characteristics to a corresponding region of the person's body.

### BACKGROUND

1. Technical Field

Methods and apparatuses consistent with the present invention relate generally to providing a sleep system having zoned support and zoned comfort. More particularly, these methods and apparatuses relate to providing a sleep system comprising at least a first layer and a second layer so as to provide zoned support and zoned comfort, respectively, for a person disposed on the sleep system.

2. Description of the Related Art

A wide variety of different sleep systems are currently available. Such sleep systems may comprise all aspects of a bedding assembly including, but not limited to, mattresses, box springs, foundation units, bed frames, pillows, mattress pads, linens and, more generally, to any type of sleep product that influences a person's sleep. However, each respective sleep system may be suitable for some persons but not suitable for others persons. The characteristics of a suitable sleep system for a person depend on a number of factors including, but not limited to, the physical attributes of the person (e.g., weight, height, body dimensions, weight distribution, etc.), preferred sleeping positions (e.g., sleeping on back, side, front, etc.), sleeping habits and so on.

Two very different primary components of sleep systems affect a person's overall sleep experience: support and comfort. First, a sleep system delivers support to a person by holding the person in a proper postural alignment. For example, a mattress may deliver support through the resistance provided by innersprings to the downward force applied due to the person's body weight.

Second, a sleep system delivers comfort to a person's body through the use of comfort materials layered on a top region of the sleep surface which evenly redistributing the person's body weight across a wide area so as to minimize interface pressure. For instance, by layering firming pads and harder, high density foam on top of the innersprings, a mattress can be manufactured to provide varying levels of hardness or firmness. On the other hand, by layering soft materials over the innersprings like convoluted foam, low density foam and/or fiber materials like wool, silk or cashmere, a mattress can be manufactured to provide varying levels of softness or a more plush feel.

Thus, the sleep system that is most suitable for a particular person is the sleep system that provides the best possible combination of comfort and support to the person. Further, suitable sleep systems will vary considerably based on a person's physical attributes, sleeping habits, etc.

Sleep systems employing a variable support and comfort control system have been developed by the inventors of the present application in a related provisional application entitled “Apparatuses and Methods Providing Variable Support and Variable Comfort Control of a Sleep System and Automatic Adjustment Thereof,” U.S. Provisional Application No. 61/028,591, which is incorporated herein by reference in its entirety. However, customers may prefer a custom manufactured non-adjustable or fixed sleep system for a variety of reasons such as cost, simplicity, etc.

While custom manufactured fixed zoned mattresses have been developed, such as the Anatom™ open coil or pocketed coil comfort system, such conventional fixed systems are not configured to adequately provide both optimal zoned support and optimal zoned comfort to a person. Thus, there is a need for a fixed sleep system that is custom designed and manufactured to provide optimal zoned support characteristics and optimal zoned comfort characteristics for the person, based on the person's physical attributes, sleeping habits, etc.

### SUMMARY

Methods and apparatuses consistent with the present invention relate to providing a sleep system having fixed zoned support characteristics and fixed zoned comfort characteristics. An aspect of the present invention provides an apparatus comprising a first layer configured to provide customized zoned comfort characteristics for a person, and a second layer configured to provide customized support characteristics for the person.

Another aspect of the present invention provides a method for providing a person with a sleep system that is custom manufactured to provide fixed optimal zoned support characteristics and optimal zoned comfort characteristics for the person, based on the person's physical attributes, sleeping habits, etc.

An aspect of the present invention provides a sleep support member comprising: a support layer comprising a plurality of support zones; and a comfort layer comprising a plurality of comfort zones; wherein the comfort layer is disposed above the support layer; wherein each of the support zones is configured to provide customized support characteristics to a corresponding region of a person's body; and wherein each of the comfort zones is configured to provide customized comfort characteristics to a corresponding region of the person's body.

An aspect of the present invention provides a method for recommending a sleep support member to a person, the method comprising: retrieving body profile data of the person from a storage device; analyzing the retrieved body profile data to generate a customized configuration of support zones for the person; analyzing the retrieved body profile data to generate a customized configuration of comfort zones for the person; correlating the customized configuration of support zones to sleep support member support options; correlating the customized configuration of comfort zones to sleep support member comfort options; and recommending the sleep support member using the sleep support member support options and the sleep support member comfort options.

### BRIEF DESCRIPTION OF THE DRAWINGS

The above and other aspects of the present invention will become more apparent by describing in detail illustrative embodiments thereof with reference to the attached drawings in which:

FIG. 1 illustrates a cross-sectional view of an apparatus for providing a sleep system having optimal zoned support characteristics and optimal zoned comfort characteristics according to an illustrative embodiment of the present invention; and

FIG. 2 illustrates a method for providing a person with a sleep system that is custom manufactured to provide fixed optimal zoned support characteristics and optimal zoned comfort characteristics for the person according to an illustrative embodiment of the present invention.

### DETAILED DESCRIPTION OF ILLUSTRATIVE EMBODIMENTS

Illustrative embodiments of the invention will now be described in detail with reference to the attached drawings in which like reference numerals refer to like elements.

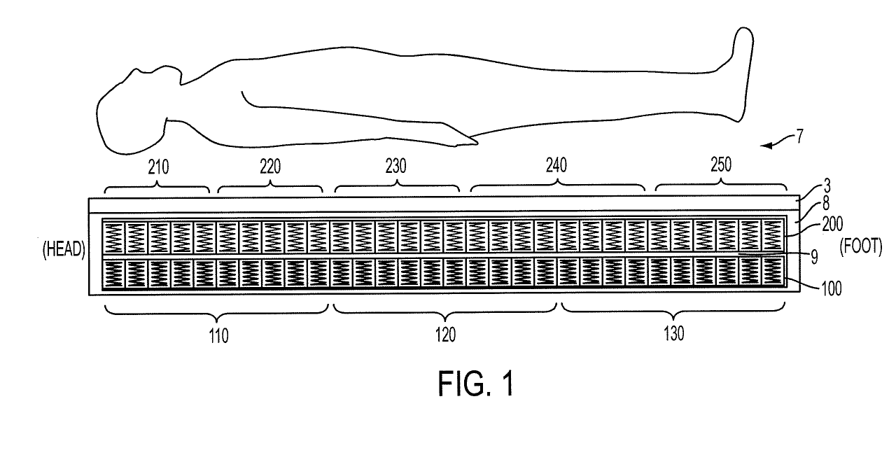

Aspects of the present invention provide an apparatus for providing a sleep system having fixed optimal zoned support and zoned comfort characteristics. FIG. 1 illustrates a cross-sectional view of an apparatus for providing a sleep system having optimal zoned support characteristics and optimal zoned comfort characteristics according to an illustrative embodiment of the present invention. As shown in FIG. 1, a sleep support member 7 comprises a zoned support layer 100 and a zoned comfort layer 200. The sleep support member 7 can be, for example, a mattress wherein the zoned support layer 100 and a zoned comfort layer 200 are encased within some type of mattress material. According to one embodiment, the sleep support member 7 may be disposed on a foundation member (not shown).

According to an illustrative embodiment, a force dispersing cover 9 may be disposed between the zoned support layer 100 and the zoned comfort layer 200. However, the present invention does not require a force dispersing cover 9. Among other things, the force dispersing cover 9 facilitates the dispersion of the force applied by each of the coils comprising the zoned support layer 100. The force dispersing cover 9 may be comprised of a wide variety of materials including, but not limited to, non-woven fabric, polystyrene, etc.

FIG. 1 also shows an illustrative embodiment wherein the zoned support layer 100 and the zoned comfort layer 200 are enclosed by a foam encasement 8. As shown in FIG. 1, an upper buildup layer 3 is disposed above the zoned comfort layer 200.

As shown in FIG. 1, the zoned support layer 100 and the zoned comfort layer 200, respectively, comprise layers of coils arranged in rows that extend laterally across the width of the sleep support member 7. However, the present invention is not limited to this illustrative configuration of coils and the rows of coils comprising the zoned support layer 100 and the zoned comfort layer 200, respectively, may extend in a longitudinal direction of the sleep support member 7 (i.e., the rows of coils may extend from the head of the sleep support member 7 to the foot of the sleep support member 7). More generally, the rows of coils comprising the zoned support layer 100 and the zoned comfort layer 200 may comprise any arrangement of coils and the present invention is not limited to any specific configuration of coils. Further, according to one illustrative embodiment, the coils comprising the zoned support layer 100 and the zoned comfort layer 200 comprise what is known in the industry as pocketed coil springs in which each coil is individually enclosed within a pocket of material.

Importantly, the present invention is not limited to a configuration employing pocketed coils or innersprings and a wide variety of support devices can be used consistent with the present invention including any system that can be configured to provide varying degrees of comfort and support. For instance, the zoned support layer 100 and the zoned comfort layer 200 may comprise support devices including, but not limited to, inflatable air members, layers of plastic based materials, gel members, foams (e.g., latex, memory foam, etc.), and so on. The zoned support layer 100 and the zoned comfort layer 200 may also comprise foam filled air bladders wherein a base pressure is produced by the foam alone and the pressure is intensified by adding air pressure. Moreover, the zoned support layer 100 and the zoned comfort layer 200 may comprise any combination of support devices and is not limited to using only one of type of support device.

As shown in FIG. 1, the zoned support layer 100 is configured to (among other things) provide optimal support characteristics for a person disposed on the sleep support member 7. That is, the zoned support layer 100 is configured to support the person in a proper postural alignment through the resistance provided by the coils of the zoned support layer 100 to the downward force applied due to the person's body weight.

In particular, the zoned support layer 100 comprises a plurality of support zones 110, 120 and 130. However, the present invention is not limited to this illustrative configuration and the zoned support layer 100 may comprise any number of support zones. Each of the support zones 110, 120 and 130 comprises a plurality of coils that may be configured to provide different support characteristics. For example, support zone 110 is located at the head, shoulders and upper back section of the sleep support member 7 and is configured to provide optimal support to the person's head, shoulders and upper back region. Similarly, support zone 120 is located at the middle section of the sleep support member 7 and is configured to provide optimal support to the person's torso and lower back region. Finally, support zone 130 is located at the legs and feet section of the sleep support member 7 and is configured to provide optimal support to the person's legs and feet region. 1231 Apparatuses and methods for objectively evaluating a person on a sleep system so as to determine the optimal comfort and support characteristics for the person have been developed by the inventors of the present application, as set forth in a related Provisional Application entitled “Apparatus and Methods for Evaluating a Person on a Sleep System,” U.S. Provisional Application No. 61/028,578, which is incorporated by reference in its entirety. The apparatuses and methods disclosed in U.S. Provisional Application No. 61/028,578 can be employed to (among other things) determine the support characteristics of the coils in each of the support zones 110, 120 and 130 that will provide the particular person with optimal support (e.g., to determine the characteristics of the coils that will support the person in a proper postural alignment). Using such determined optimal support characteristics, a sleep support member 7 can be custom manufactured for the person such that each of the support zones 110, 120 and 130 provides optimal support to a respective region of the person's body. That is, such determined optimal support characteristics can be translated into support coil firmness zones and, then, such support coil firmness zones can be manufactured to custom fit the person, so as to manufacture a sleep support member 7 that will provide fixed support characteristics that are closest to the optimal support characteristics for the person.

By way of illustration, if, using the apparatuses and methods disclosed in U.S. Provisional Application No. 61/028,578, it is determined that, based on the person's physical attributes, a large magnitude of support is optimal under the person's torso and lower back region, then the coils in support zone 120 can be configured to provide a large magnitude of support, for example, by manufacturing the coils in support zone 120 using lower gauge material. According to one embodiment, the coils in support zone 120 may be formed of 14 gauge wire (i.e., firmer coils). Likewise, if it is determined that, based on the person's physical attributes, a small magnitude of support is optimal under the person's head, shoulders and upper back region, then the coils in support zone 110 can be configured to provide a small magnitude of support, for example, by manufacturing the coils in support zone 110 using higher gauge material. For instance, according to one embodiment, the coils in support zone 110 may be formed of 16 gauge wire (i.e., softer coils).

As described above, the support zones 110, 120 and 130 comprising the zoned support layer 100 can be configured to provide a wide variety of possible combinations of zoned support for a person that are customized to the person's physical attributes, sleeping habits, etc.

FIG. 1 also shows a zoned comfort layer 200, which is configured to (among other things) provide optimal comfort characteristics for a person disposed on the sleep support member 7. That is, the zoned comfort layer 200 is configured to evenly redistribute the person's body weight across a wide area so as to minimize interface pressure at the interface between the person and the sleep support member 7.

As shown in FIG. 1, the zoned comfort layer 200 comprises a plurality of comfort zones 210, 220, 230, 240 and 250. However, the present invention is not limited to this illustrative configuration and the zoned comfort layer 200 may comprise any number of comfort zones. Each of the comfort zones 210, 220, 230, 240 and 250 comprises a plurality of coils that may be configured to provide different comfort characteristics. For example, comfort zone 210 is located at the head section of the sleep support member 7 and is configured to provide optimal comfort to the person's head region. Moreover, comfort zone 220 is located at the shoulders and upper back section of the sleep support member 7 and is configured to provide optimal comfort to the person's shoulders and upper back region. Likewise, comfort zones 230, 240 and 250 are located, respectively, at the lower back and buttocks section, the upper legs section, and the feet section of the sleep support member 7. As such, comfort zones 230, 240 and 250 are configured, respectively, to provide optimal comfort to the person's lower back and buttocks region, upper legs region, and feet region.

The apparatuses and methods disclosed in U.S. Provisional Application No. 61/028,578 can be employed to (among other things) determine the comfort characteristics of the coils in each of the comfort zones 210, 220, 230, 240 and 250 that will provide the particular person with optimal comfort (e.g., to determine the characteristics of the coils that will evenly redistribute the person's body weight across a wide area so as to minimize interface pressure). Using such determined optimal comfort characteristics, a sleep support member 7 can be custom manufactured for the person such that each of the comfort zones 210, 220, 230, 240 and 250 provides optimal comfort to a respective corresponding region of the person's body. That is, such determined optimal comfort characteristics can be translated into comfort coil firmness zones and, then, such comfort coil firmness zones can be manufactured to custom fit the person, so as to manufacture a sleep support member 7 that will provide fixed comfort characteristics that are closest to the optimal comfort characteristics for the person.

According to illustrative embodiments of the present invention, as described above, a sleep support member can be manufactured that replicates the proper zoned support and comfort required for an evaluated person.

Although illustrative embodiments described above employ the apparatuses and methods disclosed in U.S. Provisional Application No. 61/028,578 to evaluate a person and determine the optimal support and comfort characteristics for the person's sleep system, the present invention is not limited to the above illustrative configurations, and a wide variety of analysis methods and devices can be employed to evaluate a person for a custom fixed sleep system like that shown in FIG. 1. For example, systems like that disclosed in U.S. Pat. No. 6,571,192 to Hinshaw et al. (hereinafter “the '192 patent), U.S. Pat. No. 6,741,950 to Hinshaw et al. (hereinafter “the '950 patent), and U.S. Pat. No. 6,990,425 to Hinshaw et al. (hereinafter “the '425 patent), which are incorporated herein by reference in their entirety, may also be employed to measure the attributes of person(s) so as to determine the optimal zoned support and comfort characteristics of the sleep support member 7.

Moreover, while many of the above illustrative embodiments describe configuring the sleep support member 7 for a single person, according to the present invention the sleep support member 7 may also be configured to provide optimal zoned support and comfort characteristics for multiple persons (e.g., a person and the person's sleeping partner). For instance, according to one illustrative embodiment, one side of the sleep support member 7 comprises a first zoned support layer and a first zoned comfort layer configured for a person, while the other side of the sleep support member 7 comprises a second zoned support layer and a second zoned comfort layer configured for the person's sleeping partner.

As shown in FIG. 1, each of the rows of coils comprising the zoned support layer 100 is aligned with a respective row of coils comprising the zoned comfort layer 200, however, such alignment is not necessary and illustrative embodiments of the invention my comprise configurations of the zoned support layer 100 and the zoned comfort layer 200 that are not aligned.

Furthermore, although the illustrative embodiment shown in FIG. 1 comprises one zoned support layer 100 and one zoned comfort layer 200, the present invention is not limited to this configuration. In fact, illustrative embodiments of the present invention may include any number of zoned support layers and zoned comfort layers.

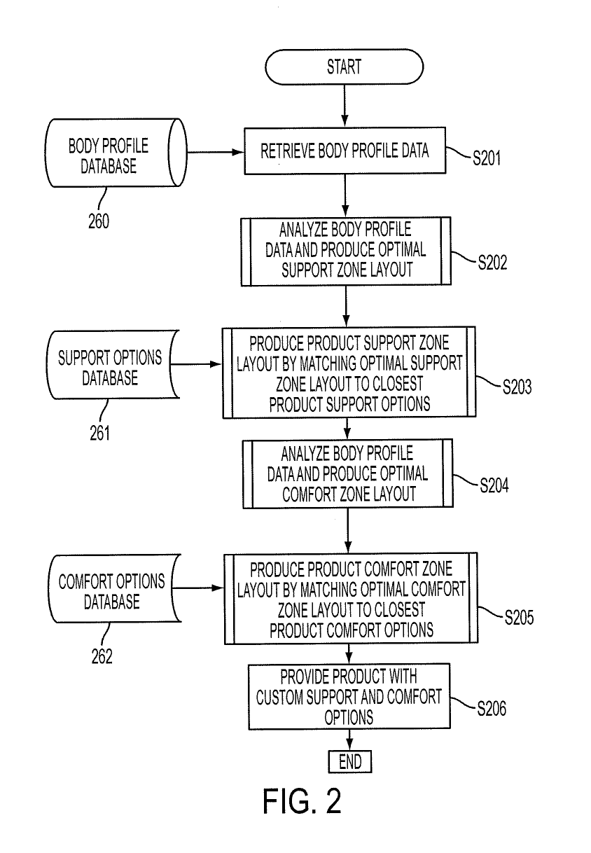

FIG. 2 illustrates a method for providing a person with a sleep system that is custom manufactured to provide optimal zoned support characteristics and optimal zoned comfort characteristics for the person according to an illustrative embodiment of the present invention. According to the illustrative embodiment shown in FIG. 2, body profile data for a person is retrieved from a body profile database 260 in operation S201. Such body profile data can be created, for example, using any of the systems and methods discussed above for evaluating a person and determining the optimal support and comfort characteristics for the person's sleep system.

In operation S202, the retrieved body profile data is analyzed and an optimal support zone layout is produced that will provide optimal zoned support characteristics for the person. In operation S203, a product support zone layout is produced by matching the optimal support zone layout to the closest product support options available using data provided by support options database 261. For example, if an optimal support zone layout is produced indicating that a large magnitude of support is optimal under the person's torso and lower back region, then such an optimal support zone layout can be matched with available product support options (e.g., firm coils, foams, gel members, inflatable members, etc.) that provide a large magnitude of support under the person's torso and lower back region. In such a manner, the optimal support zone layout can be matched with available product support options that provide optimal support characteristics for the person.

In operation S204, the retrieved body profile data is analyzed and an optimal comfort zone layout is produced that will provide optimal zoned comfort characteristics for the person. Next, in operation S205 a product comfort zone layout is produced by matching the optimal comfort zone layout to the closest product comfort options available using data provided by comfort options database 262. Accordingly, the optimal comfort zone layout can be matched with available product comfort options (e.g., coils, foams, gel members, inflatable members, etc.) that provide optimal comfort characteristics for the person.

Finally, in operation S206, the person is provided with a sleep system product having custom manufactured support and comfort options that provide the person with zoned support characteristics and zoned comfort characteristics that most closely match the person's body profile data.

The methods for providing a person with a sleep system that is custom manufactured to provide optimal zoned support characteristics and optimal zoned comfort characteristics according to illustrative embodiments of the present invention can also be embodied as computer readable codes on a computer readable recording medium. The computer readable recording medium can be any data storage device that can store data which can be read by a computer or a computer system. Examples of the computer readable recording medium include, but are not limited to, read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to illustrative embodiments thereof, it will be understood by those of ordinary skill in the art that various changes in form and details may be made therein without departing from the spirit and scope of the invention as defined by the appended claims. The illustrative embodiments should be considered in a descriptive sense only and not for purposes of limitation. Therefore, the scope of the invention is defined not by the detailed description of the invention but by the claims set forth in the related non-provisional application and all differences within the scope will be construed as being included in the present invention.

What is claimed is:

1. A sleep support member comprising:
a support layer comprising a plurality of support zones; and
a comfort layer comprising a plurality of comfort zones;
wherein the comfort layer is disposed above the support layer;
wherein each of the support zones is configured to provide customized support characteristics to a corresponding region of a person's body; and
wherein each of the comfort zones is configured to provide customized comfort characteristics to a corresponding region of the person's body.

2. The sleep support member according to claim 1, wherein a number of support zones of the support layer is different than a number of comfort zones of the comfort layer.

3. The sleep support member according to claim 1, wherein each of the support zones comprises a first plurality of support members; and
wherein each of the comfort zones comprises a second plurality of support members.

4. The sleep support member according to claim 1, further comprising a force dispersing cover disposed above the support layer and below the comfort layer.

5. The sleep support member according to claim 1, further comprising an encasement member configured to encase the support layer and the comfort layer.

6. The sleep support member according to claim 1, wherein the support members comprise coils.

7. The sleep support member according to claim 6, wherein the support members comprise pocketed coils.

8. The sleep support member according to claim 1, wherein the support members comprise at least one of a coil, an inflatable member, a layer of plastic material, a gel member, and a foam.

9. The sleep support member according to claim 1, wherein the customized support characteristics are configured to provide neutral postural alignment to the corresponding region of the person's body.

10. The sleep support member according to claim 1, wherein the customized comfort characteristics are configured to minimize interface pressure at the corresponding region of the person's body.

11. The sleep support member according to claim 1, wherein the support layer comprises a second plurality of second support zones;
wherein the comfort layer comprises a second plurality of second comfort zones;
wherein each of the second support zones is configured to provide customized support characteristics to a corresponding region of a second person's body; and
wherein each of the second comfort zones is configured to provide customized comfort characteristics to a corresponding region of the second person's body.

12. The sleep support member according to claim 1, wherein one support zone of the plurality of support zones has support characteristics that are different from another support zone of the plurality of support zones.

13. The sleep support member according to claim 1, wherein one comfort zone of the plurality of comfort zones has comfort characteristics that are different from another comfort zone of the plurality of comfort zones.

14. A method for recommending a sleep support member to a person, the method comprising:
retrieving body profile data of the person from a storage device;
analyzing the retrieved body profile data to generate a customized configuration of support zones for the person;
analyzing the retrieved body profile data to generate a customized configuration of comfort zones for the person;
correlating the customized configuration of support zones to sleep support member support options;
correlating the customized configuration of comfort zones to sleep support member comfort options; and
recommending the sleep support member using the sleep support member support options and the sleep support member comfort options.

15. The method according to claim 14, further comprising custom manufacturing the sleep support member using the sleep support member support options and the sleep support member comfort options.

16. The method according to claim 14, wherein each of the support zones is configured to provide customized support characteristics to a corresponding region of the person's body.

17. The method according to claim 14, wherein each of the comfort zones is configured to provide customized comfort characteristics to a corresponding region of the person's body.

18. The method according to claim 14, wherein the comfort zones are disposed in a comfort layer;
wherein the support zones are disposed in a support layer; and
wherein the comfort layer is disposed above the support layer.

19. The method according to claim 14, wherein the correlating the customized configuration of support zones to sleep support member support options comprises correlating the customized configuration of support zones to sleep support member support options that most accurately replicate the customized configuration of support zones from among all available sleep support member support options; and
wherein the correlating the customized configuration of comfort zones to sleep support member comfort options comprises correlating the customized configuration of comfort zones to sleep support member comfort options that most accurately replicate the customized configuration of comfort zones from among all available sleep support member comfort options.

20. The method according to claim 14, wherein the customized configuration of support zones is generated to provide neutral postural alignment for the person.

21. The method according to claim 14, wherein the customized configuration of comfort zones is generated to minimize interface pressure between the sleep support member and the person.
